(19) United States
(12) Patent Application Publication
(10) Pub. No.: US 2021/0309123 A1
(43) Pub. Date: Oct. 7, 2021

(54) SYSTEM AND METHOD FOR PERFORMING INTEGRATED CONTROL OF SEATS OF SELF-DRIVING VEHICLE

(71) Applicant: HYUNDAI TRANSYS INC., Seosan-si (KR)

(72) Inventors: Sin Jeong Kang, Hwaseong-si (KR); Duk Kyu Byun, Hwaseong-si (KR); Seong Bin Jeong, Yongin-si (KR); Byoung Wan Bae, Hwaseong-si (KR)

(21) Appl. No.: 16/682,161

(22) Filed: Nov. 13, 2019

(30) Foreign Application Priority Data
Nov. 29, 2018 (KR) 10-2018-0150330

(51) Int. Cl. B60N 2/02; B60N 2/06; B60N 2/14; B60N 2/22; B60R 7/02

(52) U.S. Cl. CPC B60N 2/0252; B60N 2/0232; B60N 2/06; B60N 2002/0272; B60N 2/22; B60R 7/02; B60N 2/14

(57) ABSTRACT

The present disclosure relates to a system and method for performing integrated control of seats of a self-driving vehicle capable of performing integrated control of swivel and displacement of front seats, rear seats, and a console in the self-driving vehicle using predetermined operation modes. The system and method for performing integrated control of the seats of the self-driving vehicle are capable of smoothly controlling swivel and displacement of the front seats, the rear seats, and the console under the control of an integrated controller according to predetermined operation modes without interference based on information about the position values of motors for the forward and rearward movement, reclining, and swivel of the front seats and rear seats (information about the amount of rotation of the motors from the original positions thereof) and information about the position value of a motor for the forward and rearward movement of the console.

### CROSS-REFERENCE TO RELATED APPLICATION

This application claims, under 35 U.S.C. § 119(a), the benefit of priority to Korean Patent Application No. 10-2018-0150330 filed on Nov. 29, 2018, the entire contents of which are incorporated herein by reference.

### BACKGROUND

### (a) Technical Field

The present disclosure relates to a system and method for performing integrated control of seats of a self-driving vehicle, and more particularly to a system and method for performing integrated control of seats of a self-driving vehicle capable of performing integrated control of swivel and displacement of front seats, rear seats, and a console in the self-driving vehicle using predetermined operation modes.

### (b) Background Art

A self-driving vehicle, which is a kind of future vehicle and is capable of driving without driver manipulation, may be provided with a linearly movable and swivel type seat configured to be moved straight forwards and rearwards and to be swiveled in a desired direction for conference and conversation between many people, for looking at a scene outside the vehicle, etc.

To this end, a base frame (a frame disposed at the bottom of a seat cushion) of the seat in the self-driving vehicle is mounted to a rail formed on a floor panel so as to be movable straight in the forward-rearward direction of a vehicle body, and the entire seat (a seat back and a seat cushion) is mounted on the base frame so as to be swiveled.

More specifically, a motor and its mechanism for moving the seat forwards and rearwards are provided between the base frame and the rail in order to move the seat so along the rail forwards and rearwards, and a motor and mechanism for swiveling the seat are provided between the base frame and the seat cushion in order to swivel the seat in a desired direction.

In addition, for the self-driving vehicle, a console that provides various convenient functions, such as article storage, an armrest, and a table, is disposed between a left seat and a right seat.

When the left seat or the right seat is moved forwards or rearwards and is thus displaced in the interior of the self-driving vehicle, however, the console becomes far away from the left seat or the right seat, whereby a user may have difficulty in using the console.

Particularly, when the left seat or the right seat is swiveled, the seat may collide with the console, i.e. interference therebetween occurs, in the case in which the console is within the rotational track of the seat, whereby the seat may not be swiveled.

Therefore, there is a necessity for a scheme that is capable of automatically moving the console to a shared position of the left seat or the right seat even when the left seat or the right seat is moved forwards or rearwards and is thus displaced in the interior of the self-driving vehicle, whereby it is possible to solve inconvenience in using the console, and that is capable of automatically moving the console out of the rotational track of the seat when the seat is swiveled, whereby it is possible to always Zo swivel the seat smoothly.

In addition, it may support a manual mode, in which a driver directly manipulates the positions of the seats, and an automatic mode, in which the seats are automatically swiveled and moved to desired positions in a specific situation, at the time of self-driving in the future such that the current positions of motors for driving the seats can be checked and thus the seats can be moved to predetermined positions without interference.

The above information disclosed in this Background section is provided only for enhancement of understanding of the background of the disclosure, and therefore, this Background section may contain information that does not form the prior art that is already known in this country to a person of ordinary skill in the art.

### SUMMARY OF THE DISCLOSURE

s Certain embodiments of the present disclosure solve the above-described problems associated with the prior art.

In an aspect of the present disclosure, a system and method are for performing integrated control of seats of a self-driving vehicle capable of smoothly controlling swivel and displacement of front seats, rear seats, and a console under the control of an integrated controller according to predetermined operation modes without interference based on information about the position values of motors for forward and rearward movement, reclining, and swivel of the front seats and rear seats (information about the amount of rotation of the motors from the original positions thereof) and information about the position value of a motor for the forward and rearward movement of the console.

The objects of the present disclosure are not limited to those described above. The objects of the present disclosure will be clearly understood from the following description and could be implemented by means defined in the claims and a combination thereof.

In one aspect, the present disclosure provides a system for performing integrated control of seats of a self-driving vehicle, the system including a first motor for seat forward and rearward movement, a second motor for seat swivel, a third motor for tilting configured to recline a seat back of each seat, a fourth motor for console forward and rearward movement, and an integrated controller configured to receive information about the current amount of rotation of each of the first to fourth motors from the original position thereof and to control driving of each of the first to fourth motors such that forward and rearward movement, reclining, and swivel of each seat and forward and rearward movement of the console are performed within a track range within which interference therebetween is avoidable.

The integrated controller may be configured to control driving of each of the first to fourth motors such that the forward and rearward movement and swivel of each seat and the forward and rearward movement of the console are performed in a plurality of predetermined operation modes in which interference therebetween is avoidable.

Each of the first to fourth motors may be provided with a rotation amount sensor for sensing the amount of rotation of the motor from the original position thereof and transmitting the same to the integrated controller.

In another aspect, the present disclosure provides a method of performing integrated control of seats of a self-driving vehicle, the method including sensing the current amount of rotation of a first motor for seat forward and rearward movement and transmitting the same to an integrated controller, sensing the current amount of rotation of a second motor for seat swivel and transmitting the same to the integrated controller, sensing the current amount of rotation of a third motor for tilting configured to recline a seat back of each seat and transmitting the same to the integrated controller, sensing the current amount of rotation of a fourth motor for console forward and rearward movement and transmitting the same to the integrated controller, and the integrated controller controlling each of the first to fourth motors based on information about the current amount of rotation of each of the first to fourth motors such that forward and rearward movement, reclining, and swivel of each seat and forward and rearward movement of the console are performed within a track range within which interference therebetween is avoidable.

When controlling each of the first to fourth motors, the integrated controller may perform control such that the forward and rearward movement and swivel of each seat and the forward and rearward movement of the console are performed in a plurality of predetermined operation modes in which interference therebetween is avoidable.

The predetermined operation modes may include a relaxation mode for passengers on front seats, a conversation mode, in which the front seats and rear seats face each other, and a return mode, in which the front seats and the rear seats are returned to the original positions thereof.

The relaxation mode may include a process of moving the front seats and the rear seats rearwards from the original positions thereof, at which the front seats and the rear seats face in the forward direction, a process of reclining the seat backs of the front seats and the rear seats rearwards, and a process of moving the console to a usable position between the front seats that have been moved rearwards.

The conversation mode may include a process of determining whether the front seats can be swiveled toward the rear seats without interference based on the information about the current amount of rotation of each of the first to fourth motors, a process of moving the front seats to a position at which interference is avoidable and then swiveling the front seats toward the rear seats, and a process of moving the console to a shared position between the front seats and the rear seats.

The return mode may include a process of checking positions of the front seats and the rear seats based on the information about the current amount of rotation of each of the first to fourth motors, a process of determining whether swivel of the front seats or the rear seats is necessary to move the front seats or the rear seats to the original positions thereof, a process of moving the front seats or the rear seats to be swiveled to a position at which interference is avoidable, swiveling the front seats or the rear seats, and moving the front seats or the rear seats forwards or rearwards to the original positions thereof, and a process of moving the console to the original position thereof.

In the conversation mode and the return mode, a stabilization process of returning the seat backs of the front seats or the rear seats to original angles may be performed before the front seats or the rear seats are swiveled in the case in which the seat backs of the front seats or the rear seats are reclined rearwards.

Other aspects of the disclosure are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a schematic view showing an example in which seats and a console are disposed in the interior of a self-driving vehicle;

FIG. 2 is a control block diagram showing elements of a system for performing integrated control of seats of a self-driving vehicle according to the present embodiment;

FIG. 3 is a schematic view showing seat operation modes and seat arrays that can be realized through integrated control of the seats of the self-driving vehicle according to the present embodiment;

FIGS. 4A and 4B are flowcharts showing an example of a method of performing integrated control of seats of a self-driving vehicle according to the present embodiment;

FIGS. 5A and 5B are flowcharts showing another example of the method of performing integrated control of the seats of the self-driving vehicle according to the present embodiment; and

FIGS. 6A to 6C are schematic views showing an example in which the seats and a console are displaced according to predetermined operation modes at the time of integrated control of the seats of the self-driving vehicle according to the present embodiment.

It should be understood that the appended drawings are not necessarily to scale, presenting a somewhat simplified representation of various features illustrative of the basic principles of the embodiment. The specific design features of the present embodiment as disclosed herein, including, for example, specific dimensions, orientations, locations, and shapes, will be determined in part by the particular intended application and use environment.

In the figures, reference numbers refer to the same or equivalent parts of the present embodiment throughout the several figures of the drawing.

### DETAILED DESCRIPTION

Reference will now be made in detail to various embodiments of the present disclosure, examples of which are illustrated in the accompanying drawings and described below. However, the present disclosure may be embodied in many different forms and should not be construed as limited to the embodiments set forth herein. Rather, these embodiments are provided so that this disclosure will be thorough and complete, and will fully convey the scope of the disclosure to those skilled in the art.

In addition, the term “unit” or “assembly” used herein signifies one unit that processes at least one function or operation, and may be realized by hardware, software, or a combination thereof.

In addition, relational terms, such as “first” and “second,” are used in this specification only to distinguish between the same elements, and the elements are not limited as to the sequence therebetween in the following description.

Since the forward-rearward movement, swivel operation, and reclining operation of each seat of a self-driving vehicle should be smoothly performed without interference in a limited interior space, the seat may be manufactured so as to have a slim structure that has a smaller volume than a conventional seat. In addition, a center console, disposed between left and right seats, may be configured so as to be movable in response to the movement and swivel operation of the seat.

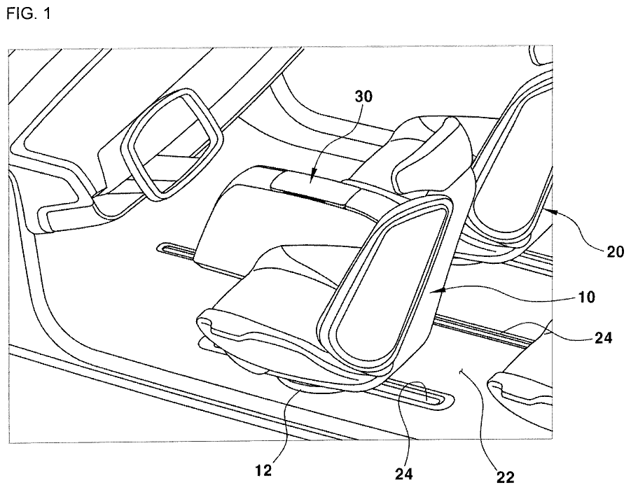

As shown in FIG. 1, each of front seats 10 and 20, disposed in a limited interior space of the self-driving vehicle, is configured to have a slim structure such that the forward-rearward movement and swivel operation of the seat are easily performed, and a console 30, disposed between the front seats 10 and 20, is automatically moved to a usable position adjacent to the seat when the seat is moved in the forward-rearward direction. In addition, the console is automatically moved to a position at which interference between the console and the seat is avoided when the seat is swiveled.

To this end, as shown in FIG. 1, a base frame 12 of each of the seats 10 and 20 of the self-driving vehicle is mounted to a rail 24 (e.g. a mono rail) formed on a floor panel 22 so as to be movable straight in the forward-rearward direction of a vehicle body, and the entire seat (a seat back and a seat cushion) is mounted on the base frame 12 so as to be swiveled.

In addition, the console 30 may also be mounted to a rail 24 (e.g. a mono rail) formed on the floor panel 22 so as to be movable forwards and rearwards.

For reference, a seat forward and rearward movement mechanism including a first motor for seat forward and rearward movement, a seat swivel mechanism including a second motor for seat swivel, an automatic reclining mechanism including a third motor for tilting configured to recline seat backs of the seats, and a console forward and rearward movement mechanism including a fourth motor for console forward and rearward movement may be variously designed and manufactured using a common rail, a common motor, and a common power transmission device arranged between the rail and the motor and have no relation to the essence of the present embodiment, and therefore a detailed description thereof will be omitted.

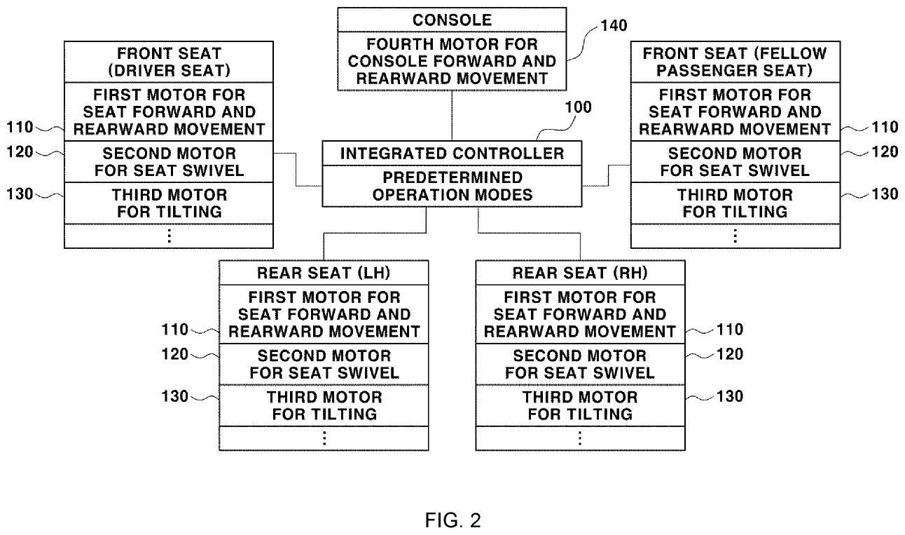

FIG. 2 is a control block diagram showing elements of a system for performing integrated control of seats of a self-driving vehicle according to the present embodiment, wherein reference numeral 100 indicates an integrated controller.

The integrated controller 100 controls, in an integrated manner, on/off and the amount of rotation of motors included in seats and a console such that the forward and rearward movement, reclining, and swivel of the seats and the forward and rearward movement of the console are performed within a track range within which interference therebetween is avoidable using a wired or wireless communication module.

Each of front seats (a driver seat 10 and a fellow passenger seat 20) and rear seats (a rear left seat and a rear right seat) includes a first motor 110 for seat forward and rearward movement, a second motor 120 for seat swivel, and a third motor 130 for tilting configured to recline a seat back of the seat, and the console, disposed between the seats, includes a fourth motor 140 for console forward and rearward movement. On/off and the amount of rotation of the motors 110, 120, 130, and 140 are controlled by the integrated controller 100 in an individual manner or in an integrated manner.

That is, the integrated controller 100 receives information about the current amount of rotation of each of the first to fourth motors 110, 120, 130, and 140 from the original position thereof (a zero point to determine the current amount of rotation of the motor), and controls, in an individual manner or in an integrated manner, on/off and the amount of rotation of the first to fourth motors such that the forward and rearward movement, reclining, and swivel of each seat and the forward and rearward movement of the console are performed within a track range within which interference therebetween is avoidable.

Each of the first to fourth motors 110, 120, 130, and 140 may be provided with a rotation amount sensor (not shown) for sensing the amount of rotation of the motor from the original position thereof and transmitting the same to the integrated controller 100.

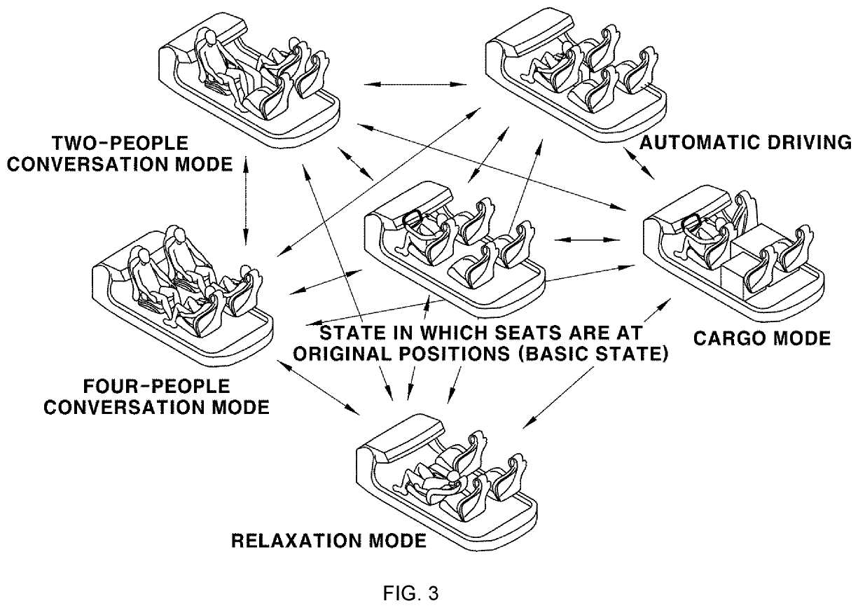

In particular, the integrated controller 100 controls on/off and the amount of rotation of the first to fourth motors 110, 120, 130, and 140 such that the forward and rearward movement and swivel of the seats and the forward and rearward movement of the console are performed in a plurality of predetermined operation modes in which interference therebetween is avoidable. The predetermined operation modes are shown in FIG. 3.

As shown in FIG. 3, the predetermined operation modes performed by the integrated controller 100 include a normal mode, a conversation mode, a relaxation mode, and a cargo mode. In the normal mode, the front seats and the rear seats are arranged at the original positions thereof at which the front seats and the rear seats face in the forward direction. In the conversation mode, one or two of the front seats are swiveled from the normal mode such that passengers can face each other. In the relaxation mode, the front seats are moved rearwards and at the same time the seat backs thereof are tilted rearwards. In the cargo mode, the rear seats are moved rearwards as much as possible to enlarge a cargo loading space. In addition, the predetermined operation modes further include various seat operation modes realized by swiveling and displacing the seats.

Hereinafter, a method of performing integrated control of the seats of the self-driving vehicle according to the present embodiment will be described in detail.

Integrated seat control of the present embodiment is performed on the premise that the first motor 110 for seat forward and rearward movement and a seat forward and rearward movement mechanism, the second motor 120 for seat swivel and a seat swivel mechanism, and the third motor 130 for tilting configured to recline the seat back of each seat are applied to each of the front and rear seats and that the fourth motor 140 for console forward and rearward movement and a console forward and rearward movement mechanism are applied to the console. Each motor and mechanism may be variously designed and manufactured using a common rail, a common motor, and a common power transmission device arranged between the rail and the motor and have no relation to the essence of the present embodiment, and therefore a detailed description thereof will be omitted.

First, upon receiving a user request for a target operation mode X, which is one of the predetermined operation modes (e.g. a switch operation), the integrated controller 100 checks information about the current amount of rotation of each of the first to fourth motors 110, 120, 130, and 140 from the original position thereof (a zero point to determine the current amount of rotation of the motor).

That is, the integrated controller 100 checks information about the current amount of rotation of each of the first to fourth motors 110, 120, 130, and 140 from the original position thereof (a zero point to determine the current amount of rotation of the motor) through a step of sensing the current amount of rotation of the first motor 110 for seat forward and rearward movement using the rotation amount sensor and transmitting the same to the integrated controller 100, a step of sensing the current amount of rotation of the second motor 120 for seat swivel using the rotation amount sensor and transmitting the same to the integrated controller 100, a step of sensing the current amount of rotation of the third motor 130 for tilting configured to recline the seat back of the seat using the rotation amount sensor and transmitting the same to the integrated controller 100, and a step of sensing the current amount of rotation of the fourth motor 140 for console forward and rearward movement using the rotation amount sensor and transmitting the same to the integrated controller 100.

Thereupon, the integrated controller 100 controls the amount of rotation of each of the first to fourth motors 110, 120, 130, and 140 based on the information about the current amount of rotation of each of the first to fourth motors 110, 120, 130, and 140 such that the forward and rearward movement, reclining, and swivel of each seat and the forward and rearward movement of the console are performed within a track range within which interference therebetween is avoidable. When a specific seat in the self-driving vehicle is moved forwards and rearwards or swiveled, therefore, the seat may be operated within a track range within which interference with the other seats or the console is avoidable. Thus, the forward and rearward movement and swivel of the seat may always be smoothly performed without interference.

When controlling the amount of rotation of each of the first to fourth motors 110, 120, 130, and 140, the integrated controller 100 performs control such that the forward and rearward movement and swivel of the seat and the forward and rearward movement of the console are performed within a track range within which interference therebetween is avoidable according to the predetermined operation modes.

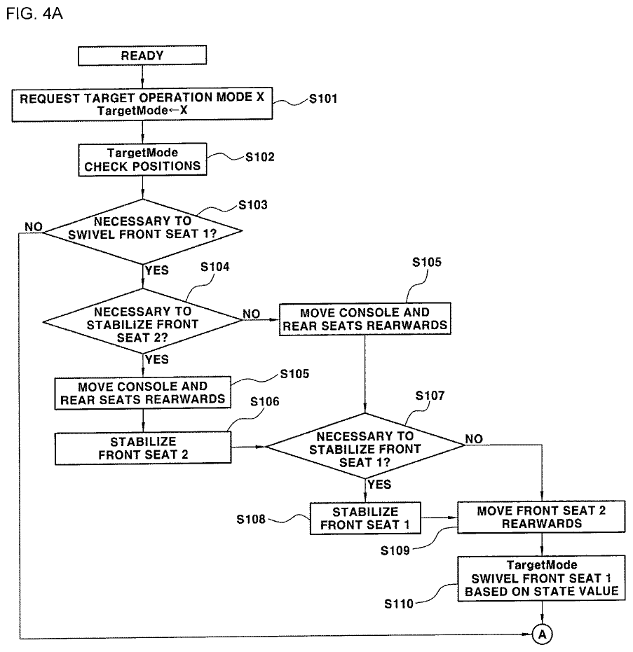

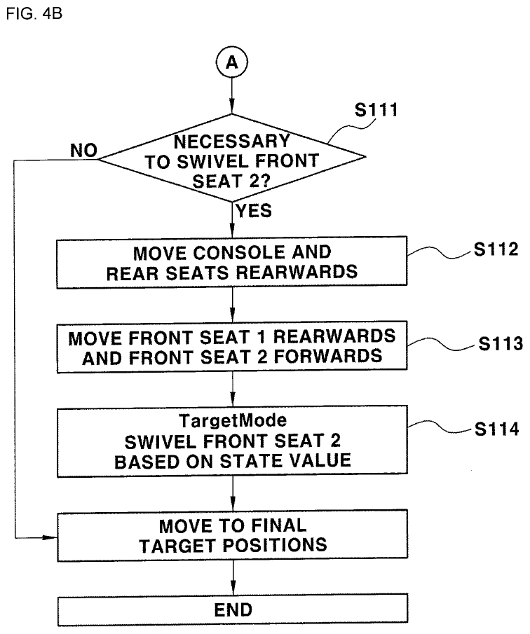

Hereinafter, an example in which the integrated controller 100 controls the amount of rotation of each of the first to fourth motors 110, 120, 130, and 140 according to the predetermined operation modes will be described with FIGS. 4A and 4B.

FIGS. 4A and 4B are flowcharts showing an example of a method of performing integrated control of the seats of the self-driving vehicle according to the present embodiment, wherein a process of swiveling front seat 1 (e.g. a driver seat 10) and front seat 2 (e.g. a fellow passenger seat 20) is shown.

First, upon receiving a user request for a target operation mode X, which is one of the predetermined operation modes (S101), the integrated controller 100 checks information about the current amount of rotation of each of the first to fourth motors 110, 120, 130, and 140 from the original position thereof (a zero point to determine the amount of rotation of the motor) (S102).

At this time, the integrated controller 100 may check the current positions and array states of the front and rear seats and the console based on the information about the current amount of rotation of each of the first to fourth motors 110, 120, 130, and 140.

Subsequently, the integrated controller 100 determines whether it is necessary to swivel front seat 1 (S103). Upon determining that it is necessary to swivel front seat 1, the integrated controller 100 determines whether it is necessary to stabilize front seat 2 such that front seat 2 does not interfere with front seat 1 when front seat 1 is swiveled (whether it is necessary to return front seat 2 to the original position thereof such that front seat 2 does not interfere with front seat 1) (S104), and performs control such that front seat 2 is stabilized (S106).

That is, since front seat 2 may interfere with front seat 1 when front seat 1 is swiveled in the state in which the seat back of front seat 2 is reclined or in the state in which front seat 2 is swiveled relative to front seat 1, the integrated controller 100 controls the motors included in front seat 2 such that front seat 2 is swiveled to the original position thereof (e.g. the position at which front seat 2 faces in the forward direction) and such that the seat back of front seat 2 returns to the original angle, whereby front seat 2 is stabilized.

At this time, the console and the rear seats are moved rearwards out of the swivel track of front seat 1 according to motor control of the integrated controller 100 (S105).

Subsequently, the integrated controller 100 determines whether it is necessary to stabilize front seat 1 (S107). Upon determining that it is necessary to stabilize front seat 1, the integrated controller 100 performs control such that front seat 1 is stabilized in the same manner as front seat 2 (S108).

After front seat 2 is stabilized, front seat 2 is moved rearwards out of the swivel track of front seat 1 according to motor control of the integrated controller 100 (S109). As a result, front seat 1 is in the state in which all causes of interference with the swivel thereof are removed, whereby front seat 1 may be smoothly swiveled (e.g. the seat that faces in the forward direction is swiveled 180 degrees in the rearward direction) according to motor control of the integrated controller 100 (S110).

After front seat 1 is swiveled, the integrated controller 100 determines whether it is necessary to swivel front seat 2 (S111). Upon determining that it is necessary to swivel front seat 2, the console is moved rearwards according to motor control of the integrated controller 100 such that the console does not interfere with front seat 2 when front seat 2 is swiveled (S112). In addition, front seat 1 is moved rearwards and at the same time front seat 2 is moved forwards according to motor control of the integrated controller 100 such that front seat 1 does not interfere with front seat 2 when front seat 2 is swiveled (S113).

As a result, front seat 2 is in the state in which all causes of interference with swivel thereof are removed, whereby front seat 2 may be smoothly swiveled (e.g. the seat that faces in the forward direction is swiveled 180 degrees in the rearward direction) according to motor control of the integrated controller 100 (S114).

As described above, the integrated controller controls the amount of rotation of each of the motors included in the seats and the console such that a specific seat is operated within a track range within which interference with the other seats or the console is avoidable, whereby forward and rearward movement and swivel of the seat may always be smoothly performed without interference.

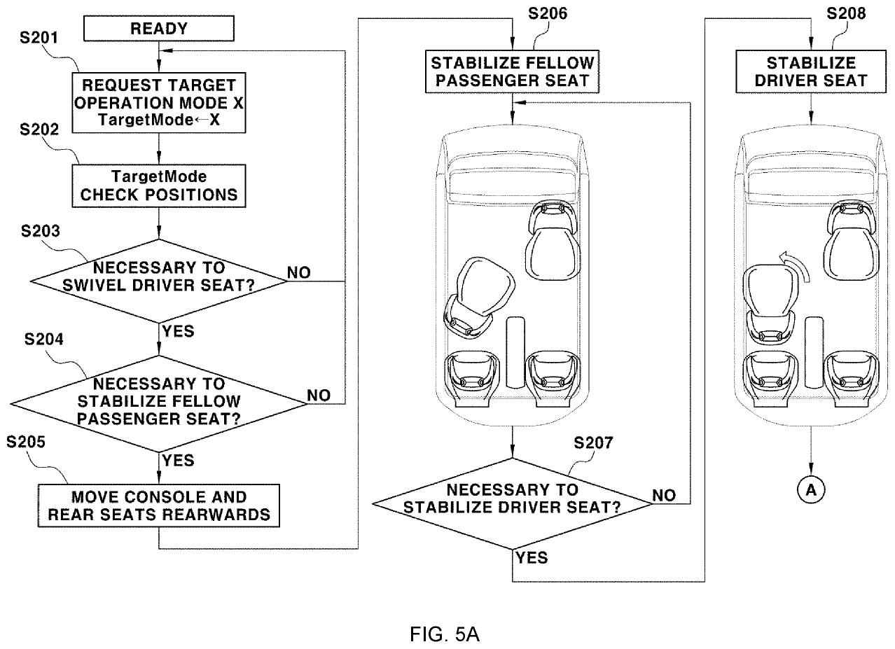

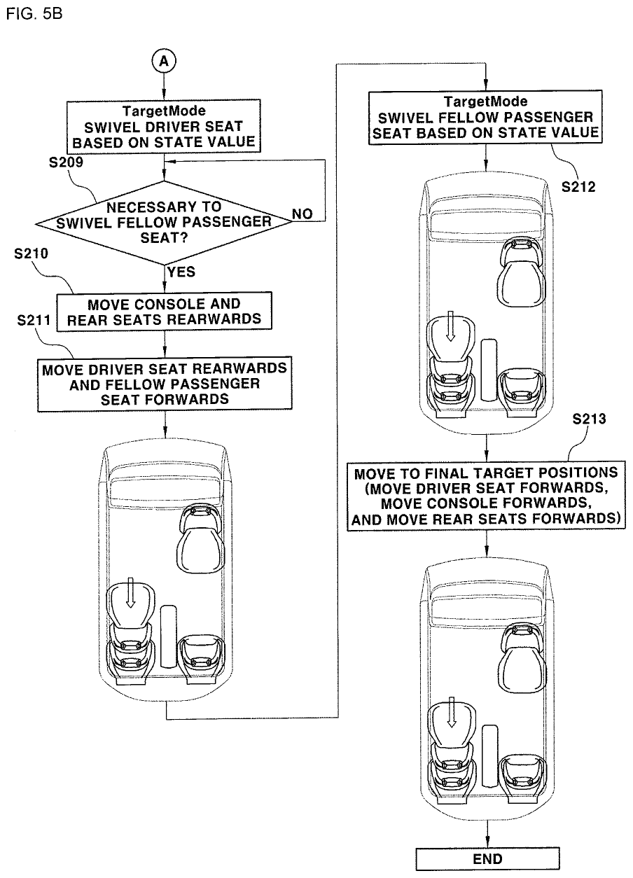

Hereinafter, another example in which the integrated controller 100 controls the amount of rotation of each of the first to fourth motors 110, 120, 130, and 140 according to the predetermined operation modes will be described with reference to FIGS. 5A and 5B.

FIGS. 5A and 5B are flowcharts showing another example of the method of performing integrated control of the seats of the self-driving vehicle according to the present embodiment, wherein a process of returning the driver seat and the fellow passenger seat to the original positions thereof in the state in which driver seat and the fellow passenger seat are moved forwards or rearwards while being changed at predetermined angles through manual manipulation is shown.

First, upon receiving a user request for a target operation mode X, which is one of the predetermined operation modes, in the state in which the driver seat and the fellow passenger seat are moved forwards or rearwards while being changed at predetermined angles through manual manipulation (S201), the integrated controller 100 checks information about the current amount of rotation of each of the first to fourth motors 110, 120, 130, and 140 from the original position thereof (a zero point to determine the current amount of rotation of the motor) (S202).

At this time, the integrated controller 100 may check the current positions and array states of the front and rear seats and the console based on the information about the current amount of rotation of each of the first to fourth motors 110, 120, 130, and 140.

Subsequently, the integrated controller 100 determines whether it is necessary to swivel the driver seat (S203). Upon determining that it is necessary to swivel the driver seat, the integrated controller 100 determines whether it is necessary to stabilize the fellow passenger seat such that the fellow passenger seat does not interfere with the driver seat when the driver seat is swiveled (whether it is necessary to return the fellow passenger seat to the original position thereof such that the fellow passenger seat does not interfere with the driver seat) (S204), and performs control such that the fellow passenger seat is stabilized (S206).

That is, since the fellow passenger seat may interfere with the driver seat when the driver seat is swiveled in the state in which the seat back of the fellow passenger seat is reclined or in the state in which the fellow passenger seat is swiveled relative to the driver seat, the integrated controller 100 controls the motors included in the fellow passenger seat such that the fellow passenger seat is swiveled to the original position thereof (e.g. the position at which the fellow passenger seat faces in the forward direction) and such that the seat back of the fellow passenger seat returns to the original angle, whereby the fellow passenger seat is stabilized.

At this time, the console and the rear seats are moved rearwards out of the swivel track of the driver seat according to motor control of the integrated controller 100 (S205).

Subsequently, the integrated controller 100 determines whether it is necessary to stabilize the driver seat (S207). Upon determining that it is necessary to stabilize the driver seat, the integrated controller 100 performs control such that the driver seat is stabilized in the same manner as the fellow passenger seat is stabilized (S208). As a result, as shown in FIG. 5, the driver seat faces in the forward direction.

At this time, upon determining that it is necessary to swivel the fellow passenger seat from the position at which the fellow passenger seat faces in the rearward direction to the position at which the fellow passenger seat faces in the forward direction (S209), the console is moved rearwards so as not to interfere with the fellow passenger seat according to motor control of the integrated controller 100 (S210). In addition, the driver seat is also moved rearwards so as not to interfere with the fellow passenger seat (S211).

As a result, the fellow passenger seat is in the state in which all causes of interference with the swivel thereof are removed, whereby the fellow passenger seat may be smoothly swiveled (e.g. the seat that faces in the rearward direction is swiveled 180 degrees in the forward direction) according to motor control of the integrated controller 100 (S212).

Subsequently, the integrated controller 100 performs control such that the driver seat is moved forwards to the original position thereof, the console is moved forwards to the original position thereof, and the rear seats are moved forwards to the original positions thereof (S213), whereby all of the seats and the console may easily be returned to the original positions thereof.

As described above, each seat and the console may automatically return to original positions thereof irrespective of the current positions of each seat and the console.

Hereinafter, an example in which integrated control of the seats of the self-driving vehicle according to the present embodiment is performed in the predetermined operation modes will be described.

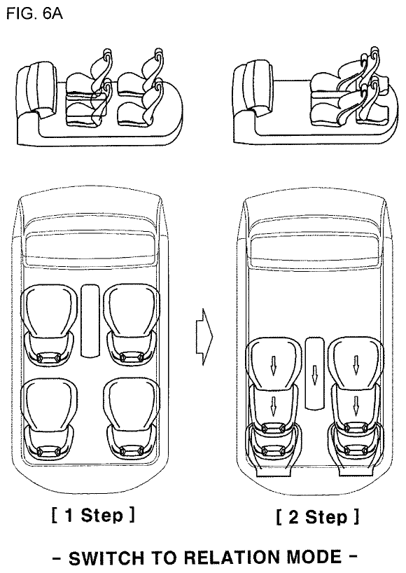

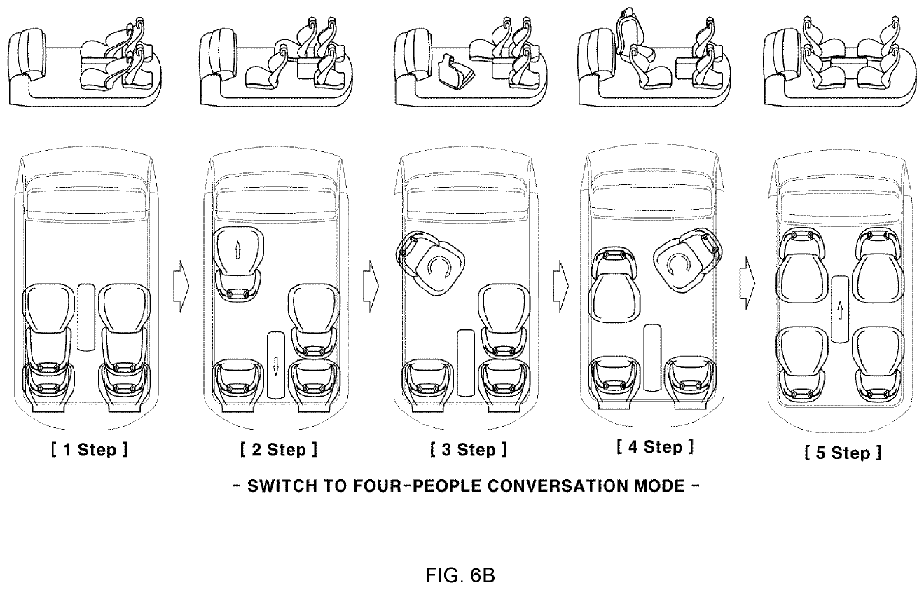

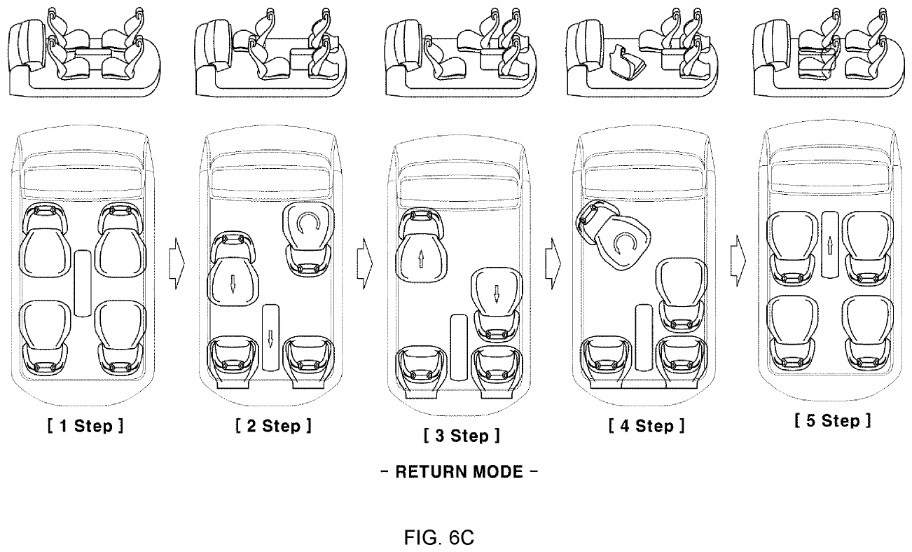

FIGS. 6A to 6C are schematic views showing an example in which the seats and the console are displaced according to the predetermined operation modes at the time of integrated control of the seats of the self-driving vehicle according to the present embodiment.

Relaxation Mode

As described above, the integrated controller 100 may control the positions of each seat and the console based on the amount of rotation of the motors included in each seat and the console, whereby a relaxation mode shown in FIG. 6A may be realized.

That is, the relaxation mode may include a process of moving the front seats and the rear seats rearwards from the original positions thereof at which the front seats and the rear seats face in the forward direction, a process of moving the rear seats rearwards as much as possible, a process of reclining the seat backs of the front seats and the rear seats rearwards, and a process of moving the console to a usable position between the front seats that have been moved rearwards.

As a result, passengers on the front seats may rest in the state of lying on their backs.

Conversation Mode

As described above, the front seats that face in the forward direction may be swiveled 180 degrees so as to face the rear seats, whereby a conversation mode, in which passengers on the front seats and passengers on the rear seats face each other, may be realized, as shown in FIG. 6B.

To this end, the conversation mode includes a process of the integrated controller determining whether the front seats (the driver seat and the fellow passenger seat) can be swiveled toward the rear seats without interference based on information about the current amount of rotation of each of the first to fourth motors, a process of moving the front seats to a position at which interference is avoidable and then swiveling the front seats toward the rear seats, and a process of moving the console to a shared position between the front seats and the rear seats.

Of course, in the conversation mode, a stabilization process of returning the seat backs of the front seats or the rear seats to the original angles is performed before the front seats or the rear seats are swiveled in the case in which the seat backs of the front seats or the rear seats are reclined rearwards.

Return Mode

A return mode is a mode in which each seat and the console are returned to the original positions thereof in the state in which each seat and the console are disposed at specific positions through manual manipulation or automatic manipulation, as shown in FIG. 6C.

To this end, the return mode includes a process of the integrated controller checking the positions of the front seats and the rear seats based on information about the current amount of rotation of each of the first to fourth motors, a process of determining whether it is necessary to swivel the front seats or the rear seats in order to move the front seats or the rear seats to the original positions thereof, a process of moving the front seats or the rear seats to be swiveled to a position at which interference is avoidable, swiveling the front seats or the rear seats, and moving the front seats or the rear seats forwards or rearwards to the original positions thereof, and a process of moving the console to the original position thereof.

Likewise, in the return mode, a stabilization process of returning the seat backs of the front seats or the rear seats to the original angles is performed before the front seats or the rear seats are swiveled in the case in which the seat backs of the front seats or the rear seats are reclined rearwards.

As described above, the seats and the console in the self-driving vehicle may be automatically moved to a position at which relaxation is possible or a position at which passengers can talk while facing each other without interference, and may then be returned to the original positions thereof, whereby it is possible for the passengers on the seats to always take a desired posture, and therefore it is possible to improve marketability of the seats of the self-driving vehicle.

As is apparent from the foregoing, the present embodiment may have the following effects.

First, the seats and the console in the self-driving vehicle may be automatically moved to a position at which relaxation is possible or a position at which passengers can talk while facing each other without interference, whereby it is possible for the passengers on the seats to always take a desired posture, and therefore it is possible to improve marketability of the seats of the self-driving vehicle.

Second, when a specific seat in the self-driving vehicle is moved forwards and rearwards or swiveled, therefore, the seat may be operated within a track range within which interference with the other seats or the console is avoidable, whereby the forward and rearward movement and swivel of the seat may always be smoothly performed.

The effects of the present embodiment are not limited to those mentioned above. It should be understood that the effects of the present embodiment include all effects that can be inferred from the foregoing description of the present embodiment.

The above detailed description illustrates the present embodiment. In addition, the foregoing describes exemplary embodiments of the present disclosure. The present embodiment may be used in various different combinations, changes, and environments. That is, variations or modifications can be made within the conceptual scope of the present embodiment, equivalents to the disclosure of the present embodiment, and/or the scope of technology and knowledge in the art to which the present embodiment pertains. The embodiments describe the best mode for realizing the technical concept of the present embodiment, and variations required for concrete application and use of the present embodiment are possible. Therefore, the above detailed description does not limit the present embodiment disclosed above. In addition, the appended claims should be interpreted to include other embodiments.

What is claimed is:

1. A system for performing integrated control of at least one seat of a self-driving vehicle, the system comprising:
a first motor for seat forward and rearward movement;
a second motor for seat swivel;
a third motor for tilting configured to recline a seat back of the at least one seat;
a fourth motor for console forward and rearward movement; and
an integrated controller configured to receive information about a current amount of rotation of each of the first motor, the second motor, the third motor, and the fourth motor from an original position of each of the first motor, the second motor, the third motor, and the fourth motor and to control the first motor, the second motor, the third motor, and fourth motor such that forward and rearward movement, reclining, and swivel of the at least one seat and forward and rearward movement of the console are performed within a track range to avoid interference with the forward and rearward movement, the reclining, and the swivel of the at least one seat.

2. The system according to claim 1, wherein the integrated controller is configured to control the first motor, the second motor, the third motor, and the fourth motor such that the forward and rearward movement and swivel of the at least one seat and the forward and rearward movement of the console are performed in a plurality of predetermined operation modes in which interference therebetween is avoidable.

3. The system according to claim 1, wherein each of the first motor, the second motor, the third motor, and the fourth motor is provided with a rotation amount sensor for sensing an amount of rotation of each of the first motor, the second motor, the third motor, and the fourth motor from the original position each of the first motor, the second motor, the third motor, and the fourth motor and transmitting the amount of rotation of each of the first motor, the second motor, the third motor, and the fourth motor to the integrated controller.

4. A method of performing integrated control of at least one seat of a self-driving vehicle, the method comprising:
sensing a current amount of rotation of a first motor for seat forward and rearward movement and transmitting the same to an integrated controller;
sensing a current amount of rotation of a second motor for seat swivel and transmitting the same to the integrated controller;
sensing a current amount of rotation of a third motor for tilting configured to recline a seat back of the at least one seat and transmitting the same to the integrated controller;
sensing a current amount of rotation of a fourth motor for console forward and rearward movement and transmitting the same to the integrated controller; and
controlling, by the integrated controller, each of the first to fourth motors based on the current amount of rotation of each of the first motor, the second motor, the third motor, and the fourth motor such that forward and rearward movement, reclining, and swivel of the at least one seat and forward and rearward movement of the console are performed within a track range to avoid interference with the forward and rearward movement, the reclining, and the swivel of the at least one seat.

5. The method according to claim 4, wherein, when controlling each of the first motor, the second motor, the third motor, and the fourth motor, the integrated controller performs control such that the forward and rearward movement and swivel of each seat and the forward and rearward movement of the console are performed in a plurality of predetermined operation modes to avoid interference with the forward and rearward movement, the reclining, and the swivel of the at least one seat.

6. The method according to claim 5, wherein the at least one seat comprises a front seat and a rear seat, wherein the predetermined operation modes comprise a relaxation mode for passengers on the front seat, a conversation mode, in which the front seat and the rear seat face each other, and a return mode, in which the front seat and the rear seat are returned to original positions thereof.

7. The method according to claim 6, wherein the relaxation mode comprises:
a process of moving the front seat and the rear seat rearwards from the original positions of the front seat and rear seat, at which the front seat and the rear seat face in a forward direction, a process of reclining the seat backs of the front seat and the rear seat rearwards, and
a process of moving the console to a predetermined position as the front seat has been moved rearwards.

8. The method according to claim 6, wherein the conversation mode comprises:
a process of determining whether the front seat can be swiveled toward the rear seat without interference based on the current amount of rotation of each of the first motor, the second motor, the third motor, and the fourth motor,
a process of moving the front seat to a position at which interference is avoidable and then swiveling the front seat toward the rear seat, and
a process of moving the console to a shared position between the front seat and the rear seat.

9. The method according to claim 6, wherein the return mode comprises:
a process of checking positions of the front seat and the rear seat based on the current amount of rotation of each of the first motor, the second motor, the third motor, and the fourth motor,
a process of determining whether swivel of the front seat or the rear seat is necessary to move the front seat or the rear seat to the original positions of the front seat or the rear seat,
a process of moving the front seat or the rear seat to be swiveled to a position at which interference is avoidable, swiveling the front seat or the rear seat, and moving the front seat or the rear seat forwards or rearwards to the original positions of the front seat or the rear seat, and
a process of moving the console to an original position of the console.

10. The method according to claim 6, wherein, in the conversation mode and the return mode, a stabilization process of returning the seat backs of the front seat or the rear seat to original angles is performed before the front seat or the rear seat are swiveled in a case in which the seat backs of the front seat or the rear seat are reclined rearwards.
